(19) United States
(12) Patent Application Publication
(10) Pub. No.: US 2007/0288711 A1
(43) Pub. Date: Dec. 13, 2007

(54) Snapshot copy management method used for logic volume manager

(75) Inventors: Yuen-Hong Chen, Tianjin (CN); Tom Chen, Taipei (TW); Win-Harn Liu, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/448,812

(22) Filed: Jun. 8, 2006

(51) Int. Cl. G06F 12/16

(52) U.S. Cl. 711/162

(57) ABSTRACT

A logic volume snapshot copy management method used for a logic volume manager. When there is a data write-in request, the plurality of snapshot copies established in the logic volume corresponding to the various time points are utilized to search in the logic volume for the data address of the data to be written. Then the data are copied into the snapshot copy of the last time point, at the data address of the data to be written in the logic volume, by Copy-On-Write (COW) operation. When there is a snapshot copy read request, the snapshot copy data at the requested data address is to be retrieved. Through the method, the function of a high-speed snapshot copy can be realized. In addition, the storage space used for a snapshot copy can be reduced.

### BACKGROUND

1. Field of Invention

The invention relates to a Logic Volume Management Method, and in particular to a Logic Volume Snapshot Copy Management Method.

2. Related Art

In general, the Logic Volume Manager (LVM) is utilized to partition the space of a hard disk into a “flexible” logic volume. Through the application of LVM technology, a hard disk can be easily repartitioned into various sizes without having to be physically organized in various sectors, thus providing flexibility in magnetic disk management. The flexibility of the LVM can be realized further by partitioning a number of physical disks of different types and sizes into a plurality of Logic Volumes (LV), hereby achieving the management by means of virtual partition. Compared with the conventional partition of disks into physical sectors, the utilization of the LVM enables the computer to have a higher level disk storage, and the plurality of sectors of the hard disk are organized and managed by the LMV as a set of volumes. Under the management of the LVM, the size of the sectors can be changed or deleted at any time depending on the actual requirement, as such enlarging or reducing the capacity of the set of volumes, hereby fully utilizing the space of a hard disk. The implementation of the LVM enables the system operator to allocate the storage space more conveniently and efficiently depending on the actual requirement of the users and/or applications. Meanwhile, the utilization of the LVM also enables the management of the disk volume storage according to the user's classification, so that the system operator is able to label the magnetic disk with more substantial nomenclature rather than the physical name of the disk.

Snapshot copy technology is one of the important and essential characteristics of the LVM, which is used to copy the Logic Volume and is aimed at keeping the data of the original logic volume at a specific time point. It utilizes similar forms of storage space as the original logic volume, and is configured with an algorithm rather than through the complete clone of data. Thus, the snapshot is used to record the values corresponding to the changed address in the logic volume, hereby achieving the advantage of high speed processing and low space occupation, and is suitable for managing the storage of data which is constantly changed with time, and maintains the various versions of data at different points of time. Through the application of such a snapshot technology, the snapshot copies can be generated at various time points depending on the actual requirements, and through calculation, these snapshot copies represent the image of the original logic volume upon the creation of the snapshot copy, namely represent various versions regardless of the present condition of the logic volume.

The copy of the snapshot thus produced is not a compete clone of the original data, and is rather a copy realized through a Copy On Write (COW) technology. For one or more snapshots contained in the original Logic Volume, when a data write request is received, the data contents of the address to be written are first copied to the space of the snapshot, and then the write-in of the original logic volume is performed. When another data write request is received for the same address of the original logic volume upon the completion of the first COW operation, the COW is not performed for the snapshot. Thus, the snapshot retains the data of certain addresses of the original logic volume upon its creation. On reviewing a certain snapshot, namely, when it is desired to obtain the version of the snapshot for the original volume at a corresponding time point, the snapshot technology is used to read the data at the unchanged addresses from the original logic volume of the corresponding time point, and the data of the changed addresses from the snapshot, and then combine them into a complete version of the original logic volume at the corresponding time point.

In the application of the logic volume, usually not the data of all the addresses are revised, as such, to satisfy the actual requirements, the space occupied by the snapshot is smaller than that occupied by the logic volume, thus the advantage of the snapshot copy is that, in normal condition, the space it requires is much smaller than that of the clone copy. However, just for the same reason, if the amount of data of the changed addresses on the logic volume is more than the snapshot space can accommodate, then the Copy On Write (COW) can not be achieved by the snapshot, thus data can not be read correctly, hereby leading to the failure of the snapshot. Therefore, the risk of snapshot failure is mainly because of the risk of improper arrangement of the snapshot space.

Since the data on the logic volume may be subject to constant revision or write-in, the copies of different versions must be kept for a plurality of different time points, therefore usually a plurality of snapshots must be created, corresponding to a logic volume. In the snapshot technology of the prior art, the processing of all the snapshots is similar including the COW, so that the writing of data into the logic volume involves the writing of data into each of the respective snapshot copies. As such, due to the fact that the writing of data into the logic volume involves the writing of data into a plurality of snapshot copies, hereby reducing the speed and the efficiency of the logic volume data copy on the one hand. On the other hand, since the plurality of snapshot copies are independent in implementing the copying of data into the logic volume, a large amount of snapshot data duplication would occur at various different time points, as such increasing the utilization of the respective snapshot copy, and in turn increasing the space required by the entire snapshot copy, thus raising the risk of failure significantly.

### SUMMARY OF THE INVENTION

In view of the above-mentioned drawbacks and shortcomings of the prior art, the objective of the invention is to provide a snapshot copy management method used for the Logic Volume Manager, which can be used to realize the high speed copy function of the snapshot, while saving the storage space of the snapshot.

Therefore, to achieve the above-mentioned objectives, the invention discloses a snapshot copy management method used for the Logic Volume Manager, including the following steps: under the condition the logic volume is provided with a plurality of snapshot copies, searching the logic volume for the data address of the data to be written when the logic volume is used to perform the COW; in the snapshot copies established corresponding to the various time points, performing the copying of the data at the data address of the data to be written by making use of COW for the snapshot copy of the last time point; on receiving the snapshot reading request, determining if the requested data address is in the snapshot corresponding to the snapshot reading request; and if said requested data address is not in the snapshot copy and the time point corresponding to the snapshot is not the last time point, then searching backward through the plurality of snapshots having its time point later than that of the corresponding snapshot, searching repeatedly through the respective snapshots until it finds the requested data address, and then reads the snapshot data at the requested data address.

According to one aspect of the invention of the snapshot copy management method used for the logic volume manager, when the requested data address is in the snapshot, then read the data of the snapshot copy of the requested data address directly.

According to another aspect of the invention of the snapshot copy management method used for the logic volume manager, when the requested data address is not in the snapshot, and the time point corresponding to the snapshot copy is the last time point, then read the original data corresponding to the requested data address in the logic volume.

According to another aspect of the invention of the snapshot copy management method used for the logic volume manager, when a snapshot copy is to be deleted from a plurality of snapshot copies, and when the time point corresponding to the snapshot copy is to be deleted is not the first time point, then the to be deleted data at the data address corresponding to the snapshot copy is added into the previous snapshot copy.

In the snapshot copy management method used for the logic volume manager of the invention, when a Copy On Write (COW) operation is performed on a logic volume by making use of the relations between the original logic volume and all the corresponding snapshot copies, the write operation is performed on only the last snapshot copy. As such, not only the storage space for the snapshot can be reduced, but the inefficiency caused by writing data into a plurality of existing snapshots in the prior art can also be avoided.

In addition, in case a certain snapshot copy is to be deleted, then through the snapshot copy integration algorithm, the to be deleted data recorded in the snapshot copy is added to the previous snapshot to facilitate the execution of the snapshot copy deletion operation. As such, the deletion of a certain snapshot will not cause the data error of other snapshots just because of the interdependence of the respective snapshot copies, according to the snapshot copy management method used for the logic volume manager of the invention.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given below for illustration only, and thus is not limitative of the present invention, wherein:

FIG. 1 is a schematic diagram indicating the data address and data content for the data to be written in the logic volume at various different time points according to the prior art;

FIG. 2a is a schematic diagram of the first snapshot copy at different time points according to the snapshot copy method of the prior art;

FIG. 2b is a schematic diagram of the second snapshot copy at different time points according to the snapshot copy method of the prior art;

FIG. 2c is a schematic diagram of the third snapshot copy at different time points according to the snapshot copy method of the prior art;

FIG. 3 is a schematic diagram of the original data of the logic volume corresponding to the snapshot copy at various different time points;

FIG. 4 is a schematic diagram of a snapshot copy at various time points according to the snapshot copy management method of the logic volume manager of the invention;

FIG. 5 is a flowchart of the snapshot copy steps according to the snapshot copy management method of the logic volume manager of the invention; and

FIG. 6 is a flowchart of the snapshot read steps of the snapshot copy management method of the logic volume manager of the invention.

### DETAILED DESCRIPTION OF THE INVENTION

The purpose, construction, features, and functions of the invention can be appreciated and understood more thoroughly through the following detailed description with reference to the attached drawings.

Before the snapshot copy management method of the logic volume manager of the invention is described in detail, the method of the snapshot copy of the prior art is described accompanied with the drawing as follows.

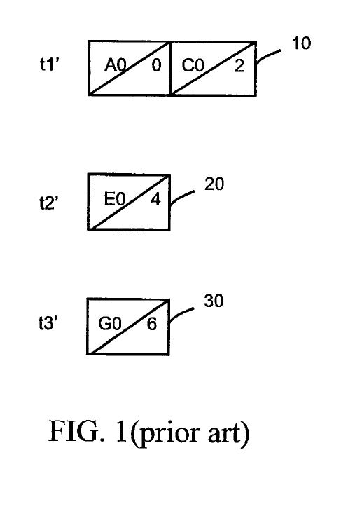

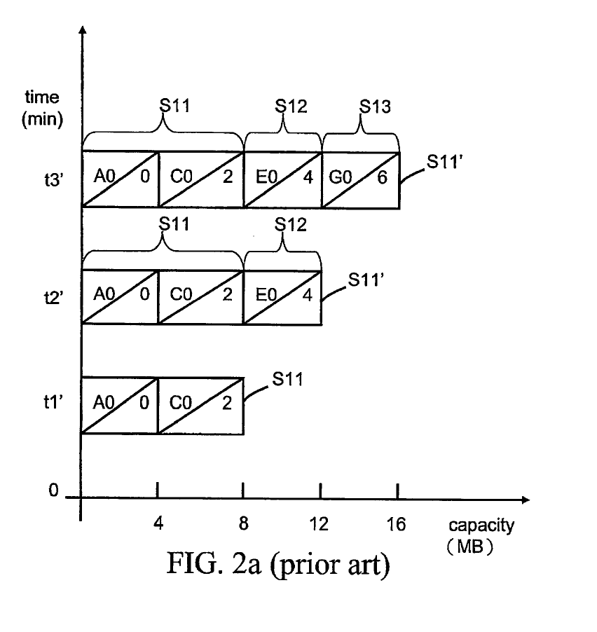

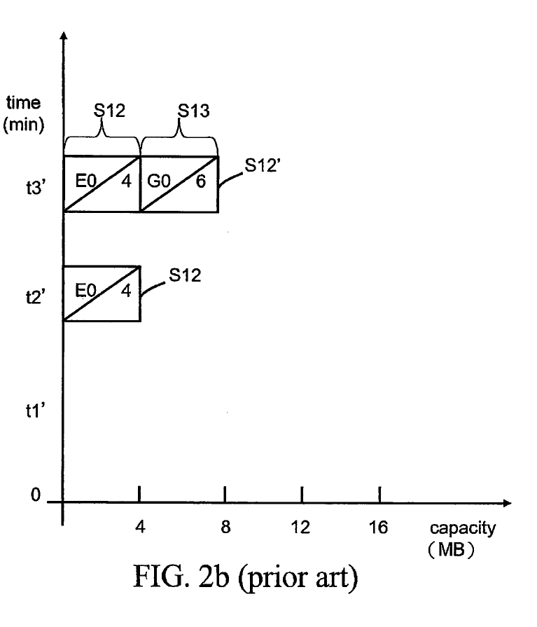

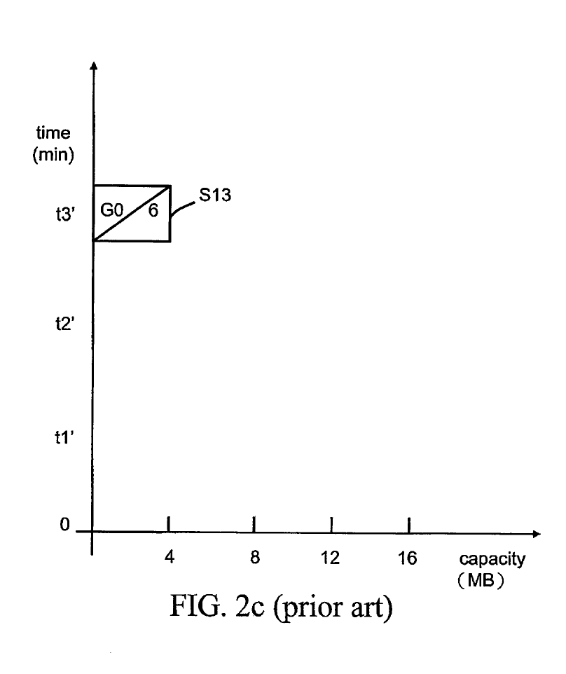

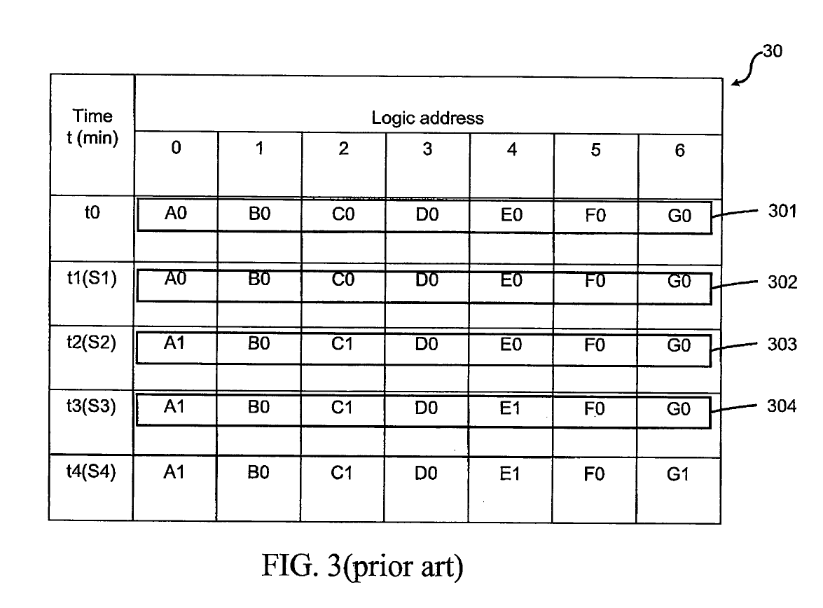

FIG. 1 is a schematic diagram indicating the data address and data content for the data to be written in the logic volume at various different time points according to the prior art. FIG. 2a is a schematic diagram of the first snapshot copy at different time points according to the snapshot copy method of the prior art. FIG. 2b is a schematic diagram of the second snapshot copy at different time points according to the snapshot copy method of the prior art. FIG. 2c is a schematic diagram of the third snapshot copy at different time points according to the snapshot copy method of the prior art. FIG. 3 is a schematic diagram of the original data of the logic volume corresponding to the snapshot copy at various different time points.

Firstly, refer to FIG. 1 for a schematic diagram indicating the data address and data content for the data to be written in the logic volume at various different time points according to prior art. As shown in FIG. 1, the logic blocks 10,20,30 at the time points t1′,t2′, and t3′ contain respectively the data address and the corresponding original data contents to be written to the logic volume.

Supposing that at time point t0 the respective address and the corresponding original data contents of the logic volume are as shown in the data area 301 of FIG. 3. FIG. 3 is a schematic diagram of the original data of the logic volume corresponding to the snapshot copy at various different time points. As shown in FIG. 3, the table 30 is composed of the two dimensional variables of the time t and logic address. At a certain time point t1, a snapshot copy S11 is generated for the present logic volume, which is now an empty snapshot copy, namely, the snapshot copy does not contain any data. At a specific time point to after the creation of the snapshot copy, namely at time point t1<t1′, the data in the logic volume are changed, for example, from data A0 to A1 at data address 0, and from data C0 to C1 at data address 2. In the above description, the data is stored in the storage unit of the logic volume, namely, the logic block. In a logic volume, “block” is utilized as a storage unit, and in a set of logic volumes, the sizes of blocks for all the logic volumes are the same. The logic volume is equivalent to a partition in a non-LVM system, and is structured over a set of logic volumes, thus it is used as a standard block, and can be used to build a file system. It is assumed that the capacity of physical block of a logic volume is 4 MB. Thus in generating a logic volume, the mapping relations between the logic blocks and physical blocks are also established. Then, through the implementation of a COW operation, and at time point t1, the snapshot copy generated is first used to record data A0 and C0, hereby obtaining the contents of the snapshot copy as shown in FIG. 2a, which includes the data A0 and C0 to be written at the logic addresses of two logic blocks.

Next, refer to FIG. 2b for a schematic diagram of the second snapshot copy at different time points according to the snapshot copy method of the prior art. As shown in FIG. 2b, the second snapshot copy refers to the snapshot copy S12. Likewise, at time point t2 a snapshot copy S12 of a logic volume is generated, at this time the snapshot copy S12 is empty. Then, subsequently, at time point t2′, namely t1′<t2<t2′, the data E0 stored at the data address 4 of the corresponding logic volume is changed to E1 by means of Copy On Write (COW) as shown in the snapshot copy S12 of FIG. 2b. According to the snapshot copy method of the prior art, while data is written into the snapshot copy S12, the same data is written into the snapshot copy S11, so that the contents of S11 are changed to the contents of the snapshot copy S11′ as shown in FIG. 2a. As shown in FIG. 2a, snapshot copy S11′ includes the data contents recorded in the original snapshot copy S11 and snapshot copy S12. Then, at the time point t3′, data G0 is written into the data address 6 corresponding to the logic volume created at the time point t3′, to obtain the snapshot copy S13 as shown in FIG. 2c. Furthermore, refer to FIG. 2c for a schematic diagram of the third snapshot copy, namely snapshot copy S13, at different time points according to the snapshot copy method of the prior art. Likewise, while data is written into the snapshot copy S13, the same data is written into the snapshot copies S11 and S12, so that the contents of S11′ and S12 are changed to the contents of the snapshot copy S11″ and S12′ respectively as shown in FIGS. 2a & 2b, wherein t2′<t3<t3′. From FIGS. 2a & 2b it is known that, at this time, the snapshot copy S11″ includes the data contents of the original snapshot copy S11, the original snapshot copy S12, and the snapshot copy S13, while the snapshot copy S12′ includes the data contents of the original snapshot copy S12 and the snapshot copy S13.

From the above-mentioned drawings it is evident that the application of the snapshot copy method of the prior art would result in writing excessive data into a plurality of snapshot copies. In addition, the quantity of the copy data of the respective snapshot copies would increase gradually, thus increasing the total space occupied by the entire snapshot copies. As such, the more frequently the snapshot copying is performed, the larger the required capacity of the logic volume will become. Thus, after the third execution of a COW of a snapshot copy, the storage capacity required by the snapshot copy S11″ may reach 16 MB.

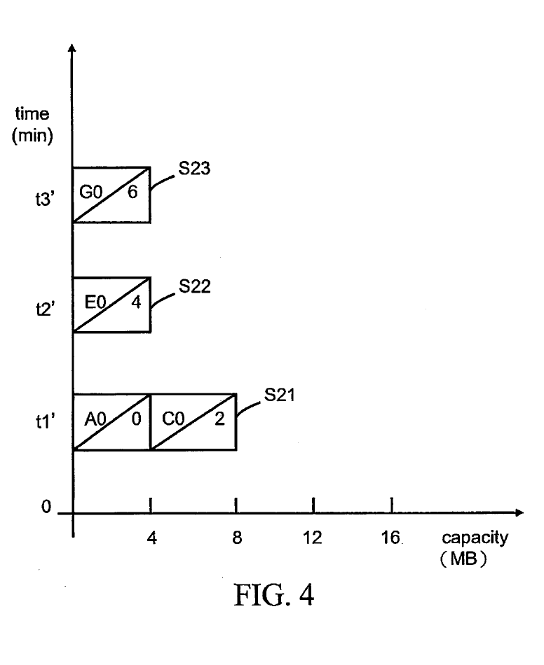

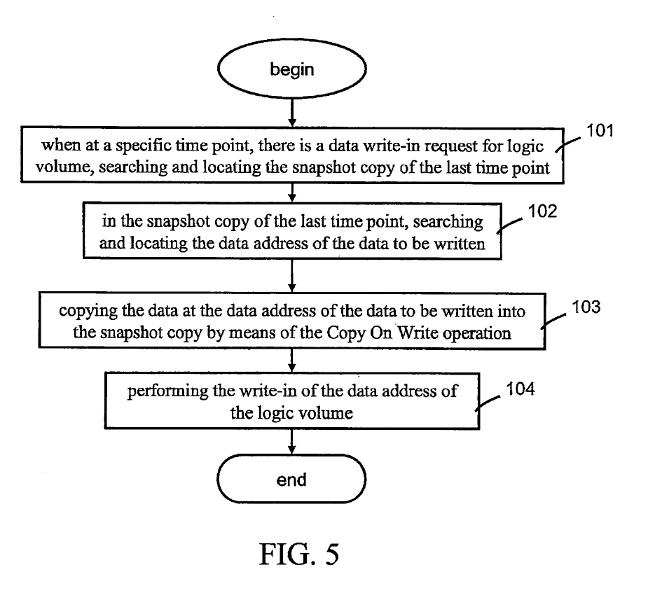

In the following, the snapshot copy management method of the logic volume manager of the invention will be described in detail accompanied with the attached drawings. FIG. 4 is a schematic diagram of a snapshot copy at different time points according to the snapshot copy method of the logic volume manager of the invention. FIG. 5 is a flowchart of the snapshot copy steps according to the snapshot copy method of the logic volume manager of the invention.

Subsequently, refer to FIG. 4 for a schematic diagram of a snapshot copy at different time points according to the snapshot copy management method of the logic volume manager of the invention, supposing that at time points t1′, t2′and t3′, the logic address and the data to be written into the logic volume are the same as those of the prior art as shown in FIG. 1.

Then, refer to FIG. 5 for a flowchart of the snapshot copy steps according to the snapshot copy management method of the logic volume manager of the invention. As shown in FIG. 5, under the condition of having created a plurality of snapshot copies for the logic volume, and when it is desired to write into the logic volume at a specific time point, searching and locating the snapshot copy created at the last time point (step 101). Next, in the snapshot copy of the last time point, searching for the data address of the data to be written from the logic volume (step 102). Then, recording the data at the data address of the data to be written thus obtained in the snapshot copy by means of COW (step 103). Finally, upon completing the recording of data into the snapshot copy, executing the writing of data having address corresponding to the logic volume (step 104). From the above description it is evident that, if only one snapshot copy is created corresponding to the logic volume, then the result achieved by the snapshot copy management method of the logic volume manager of the invention is the same as that of the prior art. In this respect, the snapshot copy technology of the snapshot management method of the invention may be explained by referring to FIG. 4 in conjunction with the snapshot copy technology of the prior art.

Similarly, supposing that the respective addresses and the corresponding original data contents of the logic volume at the time point t0 are as shown in the data area 301 of FIG. 3, and the snapshot copy S21 is created with the data corresponding to the data of the current logic volume at a specific time point t1, at this time in the snapshot copy S21 there is no any recorded data. Similar to the prior art, when performing the data writing for the logic block at the data addresses 0 and 2 at the time point t1′, where t1<t1′, the snapshot copy method of the invention is utilized to perform COW for the data to be written into the logic volume at the data address. The data at the data address to be written is copied to the initially created empty snapshot copy, thus obtaining the contents of the snapshot copy S21 corresponding to the time point t1′. Then, at the time point t2, the snapshot copy S22 is created. Subsequently, at the time point t2′, namely t1′<t2<t2′, data revision is performed for the data at the data address 4 of the logic volume, thus the content of the snapshot copy S22 at the corresponding time point t2′ is obtained through executing the COW operation. Contrary to the prior art, in the snapshot copy method of the invention, while data is written into the snapshot copy S22, the related data is not written into the snapshot copy S21. Namely, COW is performed only to the snapshot copy of the last time point. Similarly, at the time point t3, the snapshot copy S23 is created. Subsequently, at the time point t3′, namely t2′<t3<t3′, data revision is performed for the data at the data address 6 of the logic volume, thus the content of the snapshot copy S23 at the corresponding time point t3′ is obtained through executing the COW operation. Contrary to the prior art, in the snapshot copy method of the invention, while data is written into the snapshot copy S23, the related data is not written into the snapshot copies S21 and S22. Namely, COW is performed only to the snapshot copy of the last time point.

As shown in FIG. 4, the storage space required for the snapshot copy S21 is 8 MB, which is equivalent to the storage space required for the snapshot copy S11. In addition, the storage space required for the snapshot copy S22 is 4 MB, that is equivalent to the storage space required for the snapshot copy S12. Meanwhile, the storage space occupied by the snapshot copy S23 is equivalent to that occupied by the snapshot copy S13. Consequently, compared with the storage space occupied by the snapshot copy of the prior art, the storage space occupied by the snapshot copy of the invention is reduced significantly.

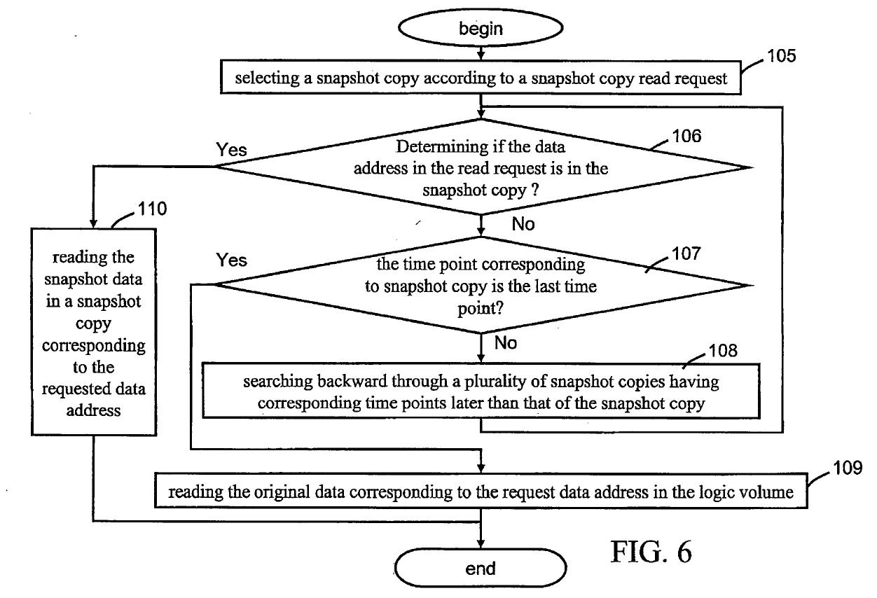

In the following, the snapshot read procedure of the logic volume manager of the invention will be described in detail according to the snapshot copy procedure of the logic volume manager of the invention. Refer to FIG. 6 for a flowchart of the snapshot read procedure of the snapshot copy management method of the logic volume manager of the invention.

As shown in FIG. 6, upon receiving a snapshot read request from a the logic volume, selecting a specific snapshot copy according to the read request (step 105), then determining if the data address in the read request is found in the selected snapshot copy (step 106). If the answer is affirmative, then reading the snapshot data directly in the snapshot copy corresponding to the requested data address (step 110). Otherwise, determining whether the time point corresponding to the current snapshot copy is the last time point (step 107). If the answer is affirmative, then proceeding to step 109 and reading the original data at the requested data address in the logic volume. If the answer is negative, then searching backward the plurality of snapshot copies having time points later than that corresponding to the snapshot copy (step 108), and determining if the data address in the read request can be found in the plurality of searched snapshot copies (step 106). If the answer if affirmative, then proceeding to step 110 to read the snapshot copy data corresponding to the request data address in the snapshot copy, as such repeating the cycle until the time point corresponding to the snapshot copy is the last time point.

Moreover, the snapshot copy procedure used for the logic volume manager can be utilized to maintain the snapshot copies of the various time points, so that if data are lost due to mishandling and/or malfunctioning of the logic volume, the snapshot read procedure may be utilized to restore the lost data. In the following, the snapshot read procedure, namely, the snapshot recovery procedure, is used to explain and describe the data recovery in conjunction with FIGS. 3 & 4. Supposing that there is a read request for the current snapshot copy S22, the selection of the snapshot copy is related to the recovery time of the logic volume contents. The selection of the snapshot copy S22 indicates that reading is required at the time point t2 for the data stored at the requested data address of a logic volume. In case it is desired to read the snapshot data corresponding to the data address 4 in the snapshot copy S22, then from FIG. 4 it is known that the data address 4 is in the snapshot copy S22, thus data reading is performed to read directly the snapshot copy data E0. In case it is desired to read the snapshot data corresponding to the data address 6 of the snapshot copy S22, then from FIG. 4 it can be determined that the data address 6 is not in the snapshot copy S22, as such it is determined that the time point corresponding to the snapshot copy S22 is the last time point. From FIG. 4, it is known that there exists another snapshot copy S23 having a time point later than that of the snapshot copy S22. Thus the searching is performed backward for the snapshot copy S23, and then it is determined that the data address 6 is in the snapshot copy S23. Since it is found that the data address 6 is indeed in the snapshot copy S23, the snapshot data G0 of the data address 6 is read. Another scenario is that there is a read request for the data at the data address 3 of the snapshot copy S23, then this data address is not in either the snapshot copy S22 or the subsequent snapshot copy S23, thus the data content D0 at the data address 3 of the logic volume is read directly to obtain the correct data. Namely, when reviewing the snapshot copy S22, its content must be jointly represented by the snapshot copy S22 and another snapshot copy S23, to obtain the correct result of the original contents of the logic volume at the time point t2, as shown in the data area 303 of table 30 in FIG. 3.

Similarly, through the snapshot copy read procedure of the invention it is known that, when reviewing the snapshot copy S21, the contents of the logic volume at the time point t1 must be jointly represented by the snapshot copy S21, another snapshot copy S22 and yet another snapshot copy S23, as shown in the data area 302 of table 30 of FIG. 3. As such, the data contents of the logic volume at time point t3 can be read directly from the snapshot copy S23, as shown in the data area 304 of table 30 in FIG. 3.

For the interdependence relations between/among the respective snapshot copies obtained through the snapshot copy procedure of the logic volume manager of the invention, except for the snapshot copy created the earliest, which may be deleted as required since it is not depended upon by other snapshot copies, yet other snapshot copies may not be deleted at will, for otherwise that would cause the data error of other snapshot copies. If it indeed has to be deleted, then the content of the snapshot copy to be deleted must first be added to its previous snapshot copy by means of snapshot copy merging, to ensure data correction for the respective snapshot copies.

Summing up the above, through the application of the snapshot copy management method of the logic volume manager of the invention, not only the storage space used for the snapshot copy can be saved, but the data write-in amount can also be reduced significantly, thus raising the snapshot copying efficiency. In addition, the data amount searched through the snapshot read procedure of the invention is the same as that of the prior art. As such, it will not affect the data reading efficiency of the snapshot copy management method of the invention.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A snapshot copy management method used for a logic volume manager, including the following steps:
on receiving a data write-in request for a logic volume, wherein said logic volume is provided with a plurality of snapshot copies corresponding to various time points, searching in said logic volume for the data address for the of the data to be written;
copying the data at the data address of the data to be written from said logic volume into the snapshot copy of the last time point by means of Copy On Write (COW) operation;
on receiving a snapshot copy read request, determining if the requested data address is in the snapshot copy corresponding to said read request; and
when said requested data address is not in the snapshot copy and said time point corresponding to said snapshot is not the last time point, then searching backward through the plurality of snapshots having time points later than that of said snapshot copy until said requested data address is found, then read the snapshot copy data at said requested data address.

2. The snapshot copy management method used for a logic volume manager as claimed in claim 1, wherein when said requested data address is in said snapshot copy, then read directly the snapshot copy data at said requested data address.

3. The snapshot copy management method used for a logic volume manager as claimed in claim 1, wherein when said requested data address is not in said snapshot copy, and said time point corresponding to said snapshot copy is said last time point, then read the original data corresponding to said requested data address in said logic volume.

4. The snapshot copy management method used for a logic volume manager as claimed in claim 1, wherein when a snapshot copy is to be deleted from a plurality of snapshot copies, and when the time point corresponding to the snapshot copy to be deleted is not the first time point, then the data at the data address of said snapshot copy to be deleted is added into the previous snapshot copy.

5. A snapshot copy management method used for a logic volume manager, including the following steps:
on receiving a data write-in request for a logic volume, wherein said logic volume is provided with a plurality of snapshot copies corresponding to various time points, searching in said logic volume for the data address for the of the data to be written;
copying the data at the data address of the data to be written from said logic volume into the snapshot copy of the last time point by means of Copy On Write (COW) operation;

6. The snapshot copy management method used for a logic volume manager as claimed in claim 5, further comprising the following steps:
on receiving a snapshot read request, determining if the requested data address is in the snapshot copy corresponding to said read request; and
when said requested data address is not in said snapshot copy and said time point corresponding to said snapshot is not the last time point, then searching backward through the plurality of snapshots having time points later than that of said corresponding snapshot until said requested data address is found, then read the snapshot copy data at said requested data address.

7. The snapshot copy management method used for a logic volume manager as claimed in claim 6, wherein when said requested data address is in said snapshot copy, then read directly the snapshot copy data at said requested data address.

8. The snapshot copy management method used for a logic volume manager as claimed in claim 6, wherein when said requested data address is not in said snapshot copy, and said time point corresponding to said snapshot copy is said last time point, then read the original data corresponding to said requested data address in said logic volume.

9. The snapshot copy management method used for a logic volume manager as claimed in claim 5, wherein when a snapshot copy is to be deleted from a plurality of snapshot copies, and when the time point corresponding to the snapshot copy to be deleted is not the first time point, then the data at the data address of said snapshot copy to be deleted is added into the previous snapshot copy.
